(19) United States
(12) Patent Application Publication
(10) Pub. No.: US 2026/0214484 A1
(43) Pub. Date: Jul. 23, 2026

(54) METHOD AND SYSTEM FOR TESTING A DUT BEING CAPABLE OF COMMUNICATING WITH A WIRELESS NETWORK BASED ON CELLS

(71) Applicant: Rohde & Schwarz GmbH & Co. KG, Munich (DE)

(72) Inventors: Reiner STUHLFAUTH, Munich (DE); Daniela RADDINO, Munich (DE); Rabih EL-MASRI, Munich (DE); Lucas CHAVARRIA-GIMENEZ, Aalborg (DK)

(21) Appl. No.: 19/029,415

(22) Filed: Jan. 17, 2025

(51) Int. Cl. H04W 24/10; H04B 17/318; H04W 36/00; H04W 74/0833

(52) U.S. Cl. CPC H04W 24/10; H04B 17/328; H04W 36/0058; H04W 74/0833

(57) ABSTRACT

The present disclosure relates to a method for testing a device under test, DUT, being capable of communicating with a wireless network based on cells. Said method comprises the steps of emulating a dynamic cell, informing the DUT about existence of said dynamic cell, measuring a first time period representing how long it takes until the DUT detects the dynamic cell and/or initiates a connection to the dynamic cell after informing the DUT about the existence of the dynamic cell, and outputting and/or displaying test results comprising said first time period.

### TECHNICAL FIELD

The present disclosure relates to a method for testing a device under test (DUT) being capable of communicating with a wireless network based on cells, and a system for testing a DUT being capable of communicating with a wireless network based on cells.

### BACKGROUND ART

In times of an increasing number of applications or devices, respectively, being capable of communicating with wireless networks based on several network nodes or cells, respectively, there is growing need of a method for testing a DUT being capable of communicating with a wireless network based on cells, and a system for testing a DUT being capable of communicating with a wireless network based on cells.

Disadvantageously, common test equipment does not allow for testing in the context of a dynamic architecture or does not allow for testing in a particularly accurate and efficient manner, respectively.

For instance, WO 2024/011193 A1 describes systems, methods, and devices related to dynamic cell reselection management. A device receives reference location and radius of a Non-Terrestrial Network (NTN) cell from system information. The device predicts a trajectory of an NTN cell center based on the received reference location and satellite ephemeris data from the system information. The device determines when the device will leave a coverage of a current serving cell based on a device location and the predicted trajectory. The device performs relaxed measurements for intra-frequency, inter-frequency, or inter radio access technology (RAT) neighbor cell measurements during a service time of the current serving cell.

Furthermore, EP 4 193 715 A1 provides a user equipment (UE), a base station, and an AMF (Access and Mobility Management Function) system, as well as corresponding methods and integrated circuits. The UE determines, based on a signal strength measurement or a position in combination with either of a list of cell IDs of earth moving cells and a timing or a stored mapping between geographical areas and tracking areas whether the UE is located in a registration area that has been indicated to the UE by the AMF and in which the UE is paged by the base station.

Moreover, US 2023/0388871 A1 relates to layer 1 (L1)/layer 2 (L2 ) triggered mobility (LTM) aspects, including LTM inter-cell mobility, LTM in split architectures; dynamic cell group changes, activation, and deactivation, conditional primary SCG cell addition or change (CPAC) aspects; early timing advance acquisition for LTM; radio link monitoring (RLM) handling for LTM; LTM-related security mechanisms; conditional handover (CHO)/CPAC aspects related to secondary cell group (SCG) configurations and radio resource control (re)configuration; and reference configuration aspects. In particular, a method of matching a flitch to a source log, and a method of modifying a log processing system, wherein the log processing system includes a first scanner optimizer and a second scanner optimizer, are provided.

In addition to this, US 2023/0328605 A1 presents methods and apparatuses for facilitating serving cell changes based on signaling related to beam management procedures in a wireless communications network. A user equipment (UE) comprises a transceiver and a processor operably coupled to the transceiver. The transceiver is configured to receive a transmission configuration indicator (TCI) state identifier (ID) associated with a target serving cell, receive a cell switch command, and transmit, in response to reception of the cell switch command, a channel conveying a positive hybrid automatic repeat request acknowledgement (HARQ-ACK). The processor is configured to perform, based on the cell switch command, a cell switch at a time, wherein the time corresponds to a slot that starts after a cell switch application time from a last symbol of the channel conveying the positive HARQ-ACK.

### SUMMARY

Thus, there is a need to provide a method for testing a DUT being capable of communicating with a wireless network based on cells, and a system for testing a DUT being capable of communicating with a wireless network based on cells, which allow not only for testing in the context of a dynamic architecture but also for testing in a particularly accurate and efficient manner.

This is achieved by the embodiments provided in the enclosed independent claims. Advantageous implementations of the present disclosure are further defined in the dependent claims.

According to a first aspect of the present disclosure, a method for testing a device under test (DUT) being capable of communicating with a wireless network based on cells is provided. Said method comprises the steps of emulating a dynamic cell, informing the DUT about existence of said dynamic cell, measuring a first time period representing how long it takes until the DUT detects the dynamic cell and/or initiates a connection to the dynamic cell after informing the DUT about the existence of the dynamic cell, and outputting and/or displaying test results comprising said first time period.

Advantageously, this allows not only for testing in the context of a dynamic architecture but also for testing in a particularly accurate and efficient manner.

According to an embodiment of the first aspect of the present disclosure, the step of informing the DUT about the existence of the dynamic cell comprises or is the steps of emulating a stationary cell with a neighbor cell list, establishing a connection between said stationary cell and the DUT, integrating the dynamic cell into the neighbor cell list, and especially sending synchronization signals and/or information regarding the dynamic cell to the DUT.

Advantageously, for instance, efficiency can be increased.

According to an embodiment of the first aspect of the present disclosure, the step of measuring the first time period comprises or is the steps of detecting the dynamic cell, especially by the DUT, and sending a measurement report regarding the dynamic cell to the stationary cell, especially by the DUT.

Advantageously, for example, the first time period can be measured in a particularly efficient manner.

According to an embodiment of the first aspect of the present disclosure, the method further comprises the step of testing of a mobility procedure of the DUT by handing over from the stationary cell to the dynamic cell, especially wherein the test results comprise a corresponding outcome of said testing of the mobility procedure of the DUT.

Advantageously, for instance, this allows for efficiently testing if the DUT communicates in a reliable manner, especially for the case that the DUT is moving, which can analogously apply for the following embodiment.

According to an embodiment of the first aspect of the present disclosure, the method further comprises the step of testing of a reverse handover of the DUT by handing over from the dynamic cell to the stationary cell, especially wherein the test results comprise a corresponding outcome of said testing of the reverse handover of the DUT.

According to an embodiment of the first aspect of the present disclosure, the dynamic cell is emulated with frequency and/or Doppler shift.

Advantageously, for example, flexibility can be increased, thereby increasing efficiency, which can analogously apply for the following embodiment.

According to an embodiment of the first aspect of the present disclosure, the dynamic cell is emulated as a low-altitude platform system, LAPS, cell and/or a high-altitude platform system, HAPS, cell.

According to an embodiment of the first aspect of the present disclosure, the dynamic cell is emulated as a non-terrestrial network, NTN, cell.

Advantageously, for instance, the dynamic cell can be based on a satellite.

According to an embodiment of the first aspect of the present disclosure, the dynamic cell is emulated as having an unpredictable trajectory.

Advantageously, for example, the dynamic cell can be based on an airplane or a drone.

According to an embodiment of the first aspect of the present disclosure, the dynamic cell is emulated such that the dynamic cell uses a corresponding frequency of an existing stationary cell, especially of the stationary cell, to inform about the existence of the dynamic cell.

Advantageously, for instance, the DUT can be informed about the existence of the dynamic cell in a particularly efficient manner.

According to an embodiment of the first aspect of the present disclosure, the method further comprises the step of measuring a second time period representing how long it takes until the DUT detects the dynamic cell after integrating the dynamic cell into the neighbor cell list, especially wherein the test results comprise said second time period.

Advantageously, for example, accuracy can further be increased.

According to an embodiment of the first aspect of the present disclosure, the dynamic cell is emulated such that the dynamic cell uses an existing synchronization signal block, SSB, grid of a stationary cell, especially of the stationary cell, and starts a transmission broadcast of its own SSB.

Advantageously, for instance, efficiency can further be increased, which can analogously apply for the following embodiment.

According to an embodiment of the first aspect of the present disclosure, the measurement report comprises a cell identifier and/or a power level and/or a reference signal received power, RSRP, with respect to the dynamic cell.

According to an embodiment of the first aspect of the present disclosure, the method further comprises the step of measuring a third time period representing how long it takes until the stationary cell receives the measurement report after detecting the dynamic cell, especially wherein the test results comprise said third time period.

Advantageously, for example, accuracy can further be increased.

According to an embodiment of the first aspect of the present disclosure, the dynamic cell is emulated such that the dynamic cell comprises a correspondingly different tracking area identifier, especially to force a tracking area update, TAU.

Advantageously, for instance, efficiency can further be increased.

According to an embodiment of the first aspect of the present disclosure, the method further comprises the step of measuring a fourth time period representing how long it takes until the DUT starts random access, preferably by sending a random access channel, RACH, preamble, after informing the DUT about the existence of the dynamic cell, especially wherein the test results comprise said fourth time period.

Advantageously, for example, accuracy can further be increased, which can analogously apply for the following embodiment.

According to an embodiment of the first aspect of the present disclosure, the method further comprises the step of measuring a fifth time period representing how long it takes until the DUT starts random access, preferably by sending a random access channel, RACH, preamble, after forcing the tracking area update, especially wherein the test results comprise said fifth time period.

According to an embodiment of the first aspect of the present disclosure, the method further comprises the step of monitoring power consumption of the DUT, preferably during informing the DUT about the existence of the dynamic cell and/or measuring the first time period, especially wherein the test results comprise said power consumption.

Advantageously, for instance, flexibility can be increased, thereby increasing efficiency, which can analogously apply for the following embodiment.

According to an embodiment of the first aspect of the present disclosure, the method further comprises the step of testing of an uplink Doppler mismatch adjustment and/or an uplink Doppler mismatch compensation of the DUT, preferably based on measuring a corresponding downlink Doppler shift with respect to the DUT and/or assuming an uplink Doppler shift with respect to the DUT, especially wherein the test results comprise a corresponding outcome of said testing of the uplink Doppler mismatch adjustment and/or of the uplink Doppler mismatch compensation of the DUT, and optionally monitoring power consumption of the DUT during said uplink Doppler mismatch adjustment and/or during said uplink Doppler mismatch compensation, especially wherein the test results comprise said power consumption.

According to a second aspect of the present disclosure, a system for testing a device under test (DUT) being capable of communicating with a wireless network based on cells is provided. Said system comprises an emulator for emulating a dynamic cell and informing the DUT about existence of said dynamic cell, a measurement device for measuring a first time period representing how long it takes until the DUT detects the dynamic cell and/or initiates a connection to the dynamic cell after informing the DUT about the existence of the dynamic cell, and an output and/or a display for outputting and/or displaying test results comprising said first time period.

Advantageously, this allows not only for testing in the context of a dynamic architecture but also for testing in a particularly accurate and efficient manner.

The above description with regard to the method according to the first aspect of the present disclosure is correspondingly valid for the system according to the second aspect of the present disclosure, and vice versa.

### BRIEF DESCRIPTION OF THE DRAWINGS

The above-described aspects and implementation forms of the present disclosure will be explained in the following description of specific embodiments in relation to the enclosed drawings, in which:

FIG. 1 shows a flow diagram of a method for testing a device under test, DUT, being capable of communicating with a wireless network based on cells according to an embodiment;

FIG. 2 shows a flow diagram of a method for testing a DUT being capable of communicating with a wireless network based on cells according to an embodiment;

FIG. 3 shows a flow diagram of a method for testing a DUT being capable of communicating with a wireless network based on cells according to an embodiment;

FIG. 4 shows a flow diagram of a method for testing a DUT being capable of communicating with a wireless network based on cells according to an embodiment;

FIG. 5 shows a flow diagram of a method for testing a DUT being capable of communicating with a wireless network based on cells according to an embodiment;

FIG. 6 shows a flow diagram of a method for testing a DUT being capable of communicating with a wireless network based on cells according to an embodiment;

FIG. 7 shows a flow diagram of a method for testing a DUT being capable of communicating with a wireless network based on cells according to an embodiment;

FIG. 8 shows a schematic diagram of a DUT communicating with a wireless network based on cells;

FIG. 9 shows a schematic diagram of a system for testing a DUT being capable of communicating with a wireless network based on cells according to an embodiment; and

FIG. 10 shows a schematic diagram of a system for testing a DUT being capable of communicating with a wireless network based on cells according to an embodiment.

### DETAILED DESCRIPTIONS OF EMBODIMENTS

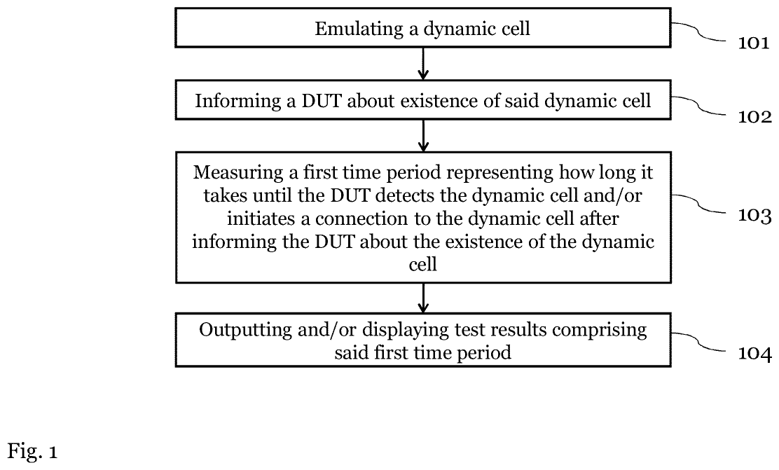

FIG. 1 illustrates a flow diagram of an embodiment of a method for testing a device under test (DUT) being capable of communicating with a wireless network based on cells.

In accordance with said FIG. 1, a step 101 comprises emulating a dynamic cell. Furthermore, a step 102 comprises informing the DUT about existence of said dynamic cell. Moreover, a step 103 comprises measuring a first time period representing how long it takes until the DUT detects the dynamic cell and/or initiates a connection to the dynamic cell after informing the DUT about the existence of the dynamic cell. In addition to this, a step 104 comprises outputting and/or displaying test results comprising said first time period. For instance, step 101 and/or step 102 can be performed with the aid of an emulator or a system simulator, respectively. Step 103 can performed with the aid of a measurement device or a measurement module, respectively.

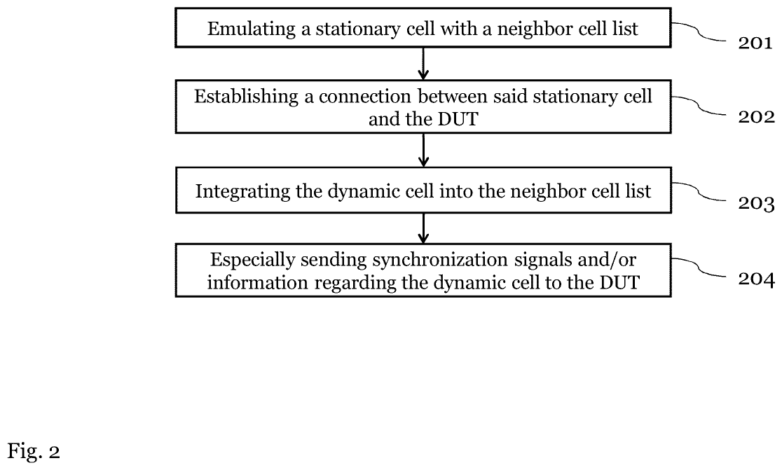

In accordance with FIG. 2 showing a flow chart of an embodiment of such a method, it might be particularly advantageous if the step 102 of informing the DUT about the existence of the dynamic cell comprises or is the following steps:
As it can be seen from said FIG. 2, a step 201 comprises emulating a stationary cell with a neighbor cell list. Furthermore, a step 202 comprises establishing a connection between said stationary cell and the DUT. Moreover, a step 203 comprises integrating the dynamic cell into the neighbor cell list, especially by the above-mentioned emulator or system simulator, respectively, or by the DUT. In particular, said step 203 may comprise integrating an entry regarding the dynamic cell into the neighbor cell list. Optionally, a step 204 comprises sending synchronization signals and/or information regarding the dynamic cell to the DUT. In particular, said step 204 may comprise sending synchronization signals and/or information regarding the dynamic cell to the DUT by the dynamic cell.

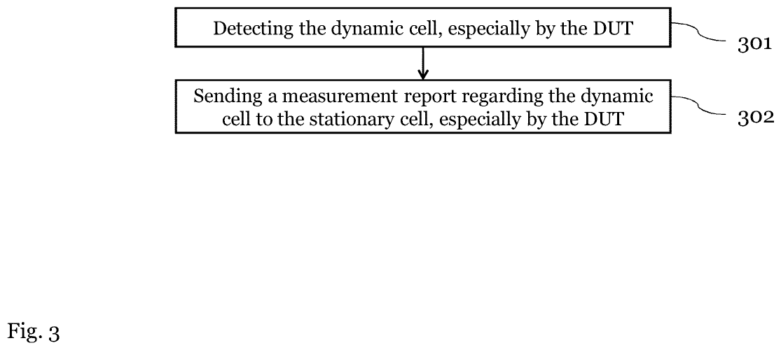

In accordance with FIG. 3 depicting a flow chart of an embodiment of such a method, it is noted that it might be particularly advantageous if the step 103 of measuring the first time period comprises or is the following steps:
As it can be seen from said FIG. 3, a step 301 comprises detecting the dynamic cell, especially by the DUT. Furthermore, a step 302 comprises sending a measurement report regarding the dynamic cell to the stationary cell, especially by the DUT.

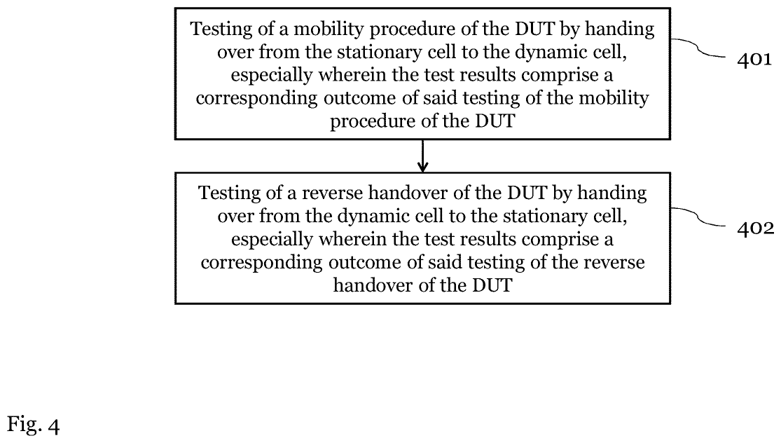

Furthermore, as illustrated by step 401 according to FIG. 4, it might be particularly advantageous if the method further comprises said step 401 of testing of a mobility procedure of the DUT by handing over from the stationary cell to the dynamic cell, especially wherein the test results comprise a corresponding outcome of said testing of the mobility procedure of the DUT.

Moreover, in accordance with step 402 of said FIG. 4, it is noted that it might be particularly advantageous if the method further comprises said step 402 of testing of a reverse handover of the DUT by handing over from the dynamic cell to the stationary cell, especially wherein the test results comprise a corresponding outcome of said testing of the reverse handover of the DUT.

It is further noted that, especially in the context of testing the reverse handover of the DUT, the dynamic cell may instruct the DUT to leave the dynamic cell. Accordingly, the step 402 of testing the reverse handover of the DUT may comprise the step of instructing the DUT to leave the dynamic cell, especially by the dynamic cell. For the sake of completeness, with respect to the stationary cell, it is noted that the stationary cell can change over time and/or position of the DUT.

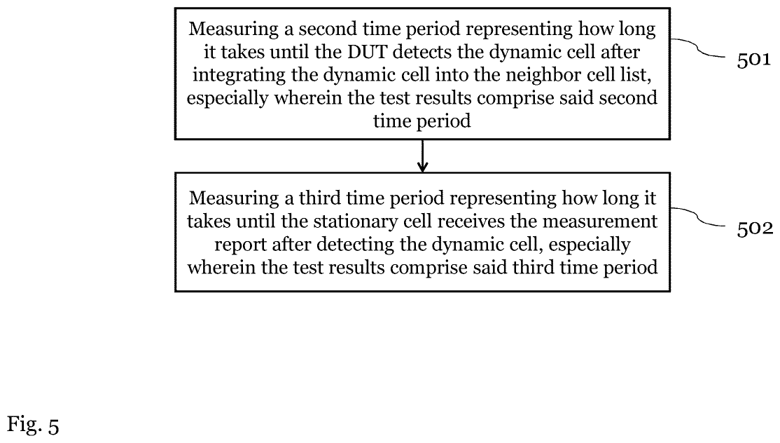

Furthermore, as illustrated by step 501 according to FIG. 5, it is noted that it might be particularly advantageous if the method further comprises said step 501 of measuring a second time period representing how long it takes until the DUT detects the dynamic cell after integrating the dynamic cell into the neighbor cell list, especially wherein the test results comprise said second time period.

Moreover, in accordance with step 502 of said FIG. 5, it might be particularly advantageous if the method further comprises said step 502 of measuring a third time period representing how long it takes until the stationary cell receives the measurement report after detecting the dynamic cell, especially wherein the test results comprise said third time period.

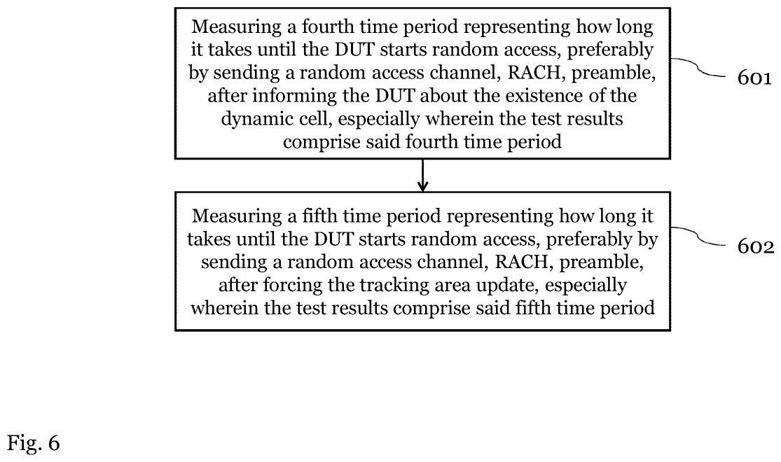

Furthermore, as depicted by step 601 according to FIG. 6, it might be particularly advantageous if the method further comprises said step 601 of measuring a fourth time period representing how long it takes until the DUT starts random access, preferably by sending a random access channel, RACH, preamble, after informing the DUT about the existence of the dynamic cell, especially wherein the test results comprise said fourth time period.

Moreover, in accordance with step 602 of said FIG. 6, it might be particularly advantageous if the method further comprises said step 602 of measuring a fifth time period representing how long it takes until the DUT starts random access, preferably by sending a random access channel, RACH, preamble, after forcing the tracking area update, especially wherein the test results comprise said fifth time period.

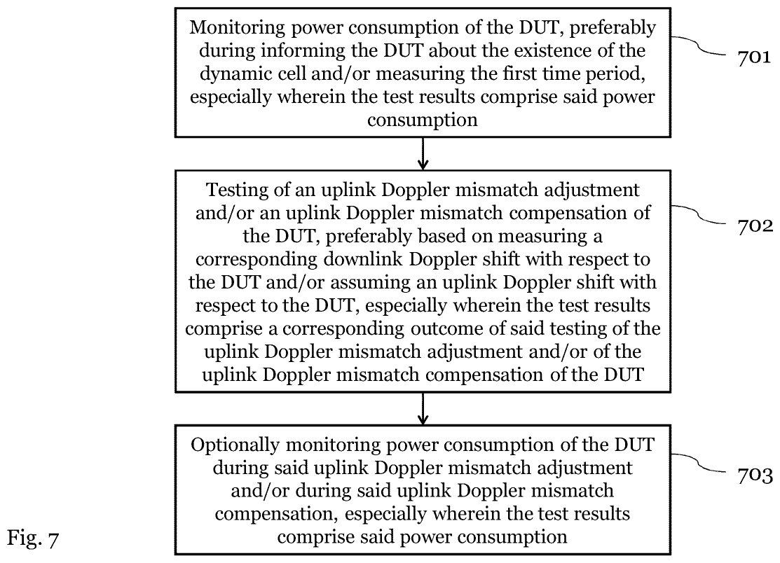

Furthermore, as illustrated by step 701 according to FIG. 7, it is noted that it might be particularly advantageous if the method further comprises said step 701 of monitoring power consumption of the DUT, preferably during informing the DUT about the existence of the dynamic cell and/or measuring the first time period, especially wherein the test results comprise said power consumption.

For the sake of completeness, it is noted that such a power consumption monitoring of the DUT can analogously apply with respect to at least one or each of the second time period, the third time period, the fourth time period, and the fifth time period, or its respectively corresponding steps, respectively.

Moreover, in accordance with step 702 of said FIG. 7, it might be particularly advantageous if the method further comprises said step 702 of testing of an uplink Doppler mismatch adjustment and/or an uplink Doppler mismatch compensation of the DUT, preferably based on measuring a corresponding downlink Doppler shift with respect to the DUT and/or assuming an uplink Doppler shift with respect to the DUT, especially wherein the test results comprise a corresponding outcome of said testing of the uplink Doppler mismatch adjustment and/or of the uplink Doppler mismatch compensation of the DUT.

For instance, with respect to said measuring the corresponding downlink Doppler shift with respect to the DUT and/or assuming the uplink Doppler shift with respect to the DUT, it is noted that it might be particularly advantageous if the uplink Doppler shift with respect to the DUT is assumed based on a correspondingly measured downlink Doppler shift with respect to the DUT. Accordingly, the step 702 can comprise testing of the uplink Doppler mismatch adjustment and/or the uplink Doppler mismatch compensation of the DUT based on an assumed uplink Doppler shift with respect to the DUT with the aid of a measured downlink Doppler shift with respect to the DUT.

Optionally, as it can further be seen from FIG. 7, the method can further comprise a step 703 of monitoring power consumption of the DUT during said uplink Doppler mismatch adjustment and/or during said uplink Doppler mismatch compensation, especially wherein the test results comprise said power consumption.

With respect to the dynamic cell, it is noted that it might be particularly advantageous if the dynamic cell is emulated with frequency and/or Doppler shift.

It is further noted that it might be particularly advantageous if the dynamic cell is emulated as a low-altitude platform system (LAPS) cell and/or a high-altitude platform system (HAPS) cell.

Moreover, it might be particularly advantageous if the dynamic cell is emulated as a non-terrestrial network (NTN) cell. In addition to this or as an alternative, it might be particularly advantageous if the dynamic cell is emulated as having an unpredictable trajectory.

Furthermore, it is noted that it might be particularly advantageous if the dynamic cell is emulated such that the dynamic cell uses a corresponding frequency of an existing stationary cell, especially of the stationary cell, to inform about the existence of the dynamic cell. Advantageously, a corresponding frequency of low reference signal received power (RSRP) existing stationary cell can be used.

It is further noted that it might be particularly advantageous if the dynamic cell is emulated such that the dynamic cell uses an existing synchronization signal block (SSB) grid of a stationary cell, especially of the stationary cell, and starts a transmission broadcast of its own SSB.

With respect to the above-mentioned measurement report, it is noted that it might be particularly advantageous if the measurement report comprises a cell identifier and/or a power level and/or a RSRP with respect to the dynamic cell.

Again, with respect to the dynamic cell, it is noted that it might be particularly advantageous if the dynamic cell is emulated such that the dynamic cell comprises a correspondingly different tracking area identifier, especially to force a tracking area update (TAU).

With respect to the method or its embodiments, respectively, as described above, it is noted that the respective procedure can be continued or extended according to state of the art registration procedures and cell acquisition procedures, especially also including multi operator scenarios.

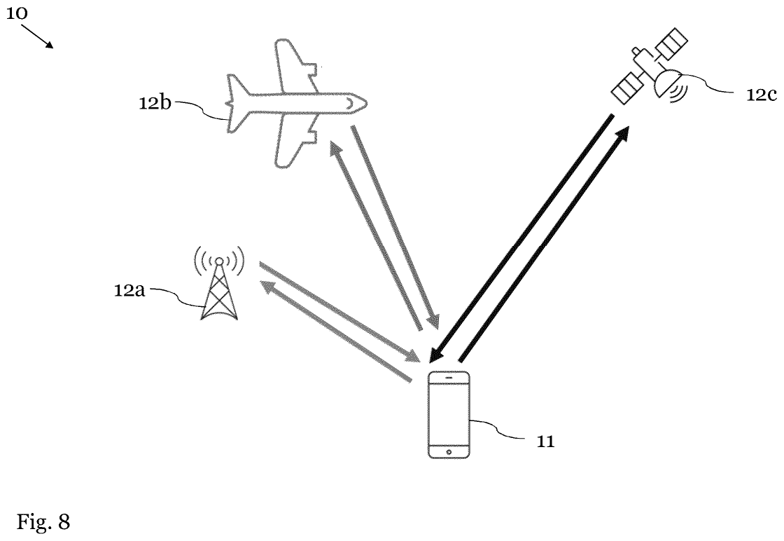

Now, with respect to FIG. 8, a schematic diagram of a DUT 11 communicating with a wireless network 10 based on cells 12a, 12b, 12c is shown. It is noted that said DUT 11 can especially be understood as a DUT as referred to above or in the following, respectively. Furthermore, said wireless network 10 can especially be understood as a wireless network as referred to above or in the following, respectively. Moreover, said cells 12a, 12b, 12c can especially be understood as cells as referred to above or in the following, respectively. For instance, the cell 12a may especially be understood as a stationary cell, and each of the cells 12b, 12c may especially be understood as a dynamic cell.

As it can be seen from said FIG. 8, in this exemplary case, the DUT 11 is a mobile phone, especially a smart phone. The cell 12a exemplarily is a terrestrial cell or a base station, respectively. The cell 12b exemplarily is an airplane with gNB (Next Generation Node B or a 5G base station, respectively). Said cell 12b especially appears dynamically and/or has no predictable trajectory. The cell 12c exemplarily is a non-terrestrial cell, especially a satellite. Said cell 12c especially is an NTN cell and/or has a known trajectory, preferably a satellite Ephemeris and/or can be predicted.

With respect to the above-mentioned satellite, it is noted that said satellite can a low earth orbit (LEO) satellite, a medium earth orbit (MEO) satellite, or a geosynchronous equatorial orbit (GEO) satellite or a geostationary orbit satellite, respectively.

With respect to the above-mentioned wireless network 10, it is noted that it might be particularly advantageous if said wireless network 10 comprises or is at least one of a non-terrestrial network (NTN), a three-dimensional network, a unified network, a three-dimensional unified network, a three-dimensional unified NTN, a 6G network, a terrestrial network, a dynamic network, or any combination thereof.

Furthermore, also with respect to the above-mentioned wireless network 10, it is noted that it might be particularly advantageous if said wireless network 10 is based on a multi-layer and/or multi-dimension and/or multi-band topology.

For instance, the wireless network 10 may especially allow for a dynamic network architecture incorporation. Accordingly, some cells or network nodes, respectively, such as LAPS or HAPS, will behave in a dynamic manner. Further exemplarily, the wireless network 10 may especially be based on a two-stage network model, i.e. the network 10 may consist of a stationary network architecture, for example, named as anchor network from perspective of the DUT 11. Those exemplarily are terrestrial, GEO or LEO satellites on a known orbit. They can provide always-on signaling information like synchronization and system information. The second part of such a network architecture can consist of a dynamic network element, for example, the above-mentioned LAPS and HAPS network nodes, that appear dynamically from the perspective of the DUT 11.

As indicated above, the present disclosure provides the emulation of such a dynamic network behavior. In addition to all the explanations above, it is noted that there are two major ways on how the DUT 11 may be informed about the existence of such dynamic network nodes.

According to a first way, neighbor cell coordination may be performed by a corresponding core network. Accordingly, the radio access network may inform the core network about the visibility of cells and their characteristics, such as cell ID, spectrum, timing, system information content, or any combination thereof. Advantageously, an update of the correspondingly existing protocol stack may be performed, especially for the case that there is a separation between AS and NAS (access stratum and non-access stratum). Further advantageously, the wireless network 10 may support an interworking between both protocol stack, AS and NAS.

According to a second way, a dynamic cell may monitor the corresponding network situation and select dynamically the corresponding synchronization information. Accordingly, the network nodes on the dynamic part may monitor the existing stationary network and will then exemplarily select a cell-defining frequency region and/or physical cell ID that is especially not interfering with existing cell information.

Furthermore, as indicated above, a test metric to be evaluated exemplarily is the time of acquisition of such a dynamic cell. For instance, the above-mentioned emulator or system simulator, respectively, starts at time t1 the emulation of a dynamic cell (e.g. LAPS) and will especially proceed with the corresponding system information updates to inform the DUT 11 about the existence of such a new cell. For example, the time can be measured how long it will take, until the DUT 11 detects the new cell. Accordingly, at time t2, the DUT 11 may detect the new cell, and for measuring the corresponding time period, t1 is subtracted from t2. Further exemplarily, the time can be measured how long it will take, until the DUT 11 sends a PRACH (Physical Random Access Channel) random access to the new cell to start a connection. Accordingly, at time t3, the DUT 11 may start the corresponding random access procedure, and for measuring the corresponding time period, t1 is subtracted from t3.

Moreover, as also indicated above, a further test metric to be evaluated exemplarily is the DUT capability to adjust the uplink Doppler mismatch. For instance, the DUT 11 can measure the downlink Doppler shift and assume the uplink Doppler.

In addition to this, and as also indicated above, it might be particularly advantageous to monitor the corresponding energy consumption of the DUT 11 during such procedures.

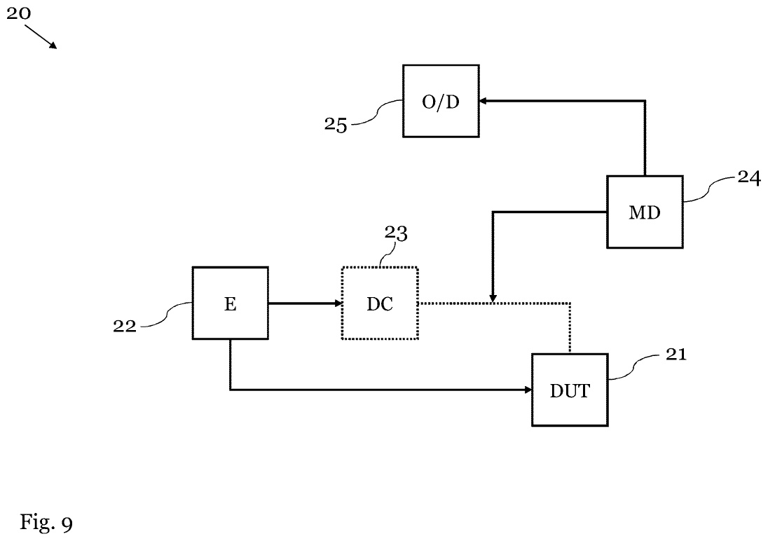

Now, with respect to FIG. 9, a schematic diagram of a system 20 for testing a DUT 21, such as the DUT 11 of FIG. 8, being capable of communicating with a wireless network, such as the wireless network 10 according to FIG. 8, based on cells, such as the cells 12a, 12b, 12c of said FIG. 8, is depicted.

In accordance with said FIG. 9, the system 20 comprises an emulator 22 or a system simulator, respectively, for emulating a dynamic cell 23 and informing the DUT 21 about existence of said dynamic cell 23, a measurement device 24 or a measurement module, respectively, for measuring a first time period representing how long it takes until the DUT 21 detects the dynamic cell 23 and/or initiates a connection to the dynamic cell 23 after informing the DUT 21 about the existence of the dynamic cell 23, and an output and/or a display 25 for outputting and/or displaying test results comprising said first time period.

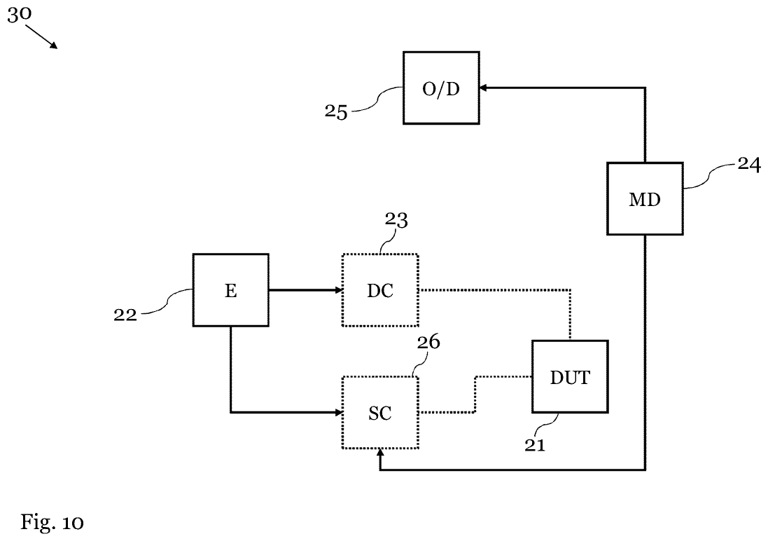

Finally, FIG. 10 illustrates a schematic diagram of a further embodiment of a system 30 being based on the system 20 according to FIG. 9. In this context, it is noted that analogous or equivalent parts or elements, respectively, depicted in FIG. 10 are not explicitly explained again but rather equipped with the same reference signs as in FIG. 9.

In this exemplary case of FIG. 10, the emulator 22 is configured to emulate the dynamic cell 23, and to emulate a stationary cell 26 with a neighbor cell list. Furthermore, the emulator 22 is configured to establish a connection between said stationary cell 26 and the DUT 21, or to emulate the stationary cell 26 such that a connection between said stationary cell 26 and the DUT 21 is established, respectively. Moreover, the emulator 22 is configured to integrate the dynamic cell 23 or an entry regarding the dynamic cell 23, respectively, into the neighbor cell list. Optionally, the emulator 22 can be configured to send synchronization signals and/or information regarding the dynamic cell 23 to the DUT 21, or to emulate the dynamic cell 23 such that the dynamic cell 23 sends synchronization signals and/or information regarding the dynamic cell 23 to the DUT 21, respectively.

For instance, the DUT 21 can detect the dynamic cell 23, and send a measurement report regarding the dynamic cell 23 to the stationary cell 26. Further exemplarily, the measurement device 24 can use said measurement report to measure the first time period representing how long it takes until the DUT 21 detects the dynamic cell and/or initiates the connection to the dynamic cell 23, especially after the DUT 21 is informed about the existence of the dynamic cell 23, or after the dynamic cell 23 or the entry regarding the dynamic cell 23, respectively, is integrated into the neighbor cell list, respectively. It is noted that the output and/or a display 25 can be configured to output and/or display the test results, exemplarily comprising the first time period and/or the measurement report.

It is noted that it might be particularly advantageous if the system 30 is configured for testing of a mobility procedure of the DUT 21 by handing over from the stationary cell 26 to the dynamic cell 23, especially wherein the test results comprise a corresponding outcome of said testing of the mobility procedure of the DUT 21. For instance, the stationary cell 26 and/or the dynamic cell 23 can be emulated accordingly. Further exemplarily, the measurement report can comprise said outcome.

It is further noted that it might be particularly advantageous if the system 30 is configured for testing of a reverse handover of the DUT 21 by handing over from the dynamic cell 23 to the stationary cell 26, especially wherein the test results comprise a corresponding outcome of said testing of the reverse handover of the DUT 21. For instance, the stationary cell 26 and/or the dynamic cell 23 can be emulated accordingly. Further exemplarily, the measurement report can comprise said outcome.

With respect to the dynamic cell 23 of FIG. 9 or of FIG. 10, respectively, it is noted that it might be particularly advantageous if the emulator 22 is configured to emulate the dynamic cell 23 with frequency and/or Doppler shift. In addition to this or as an alternative, the emulator 22 can be configured to emulate the dynamic cell 23 as a LAPS cell and/or a HAPS cell. Further additionally or further alternatively, the emulator 22 can be configured to emulate the dynamic cell 23 as an NTN cell. Additionally or alternatively, the emulator 22 can be configured to emulate the dynamic cell 23 as having an unpredictable trajectory. Further additionally or further alternatively, the emulator 22 can be configured to emulate the dynamic cell 23 such that the dynamic cell uses a corresponding frequency of an existing stationary cell, especially of the stationary cell 26, to inform about the existence of the dynamic cell 23. In addition to this or as an alternative, the emulator 22 can be configured to emulate the dynamic cell 23 such that the dynamic cell 23 uses an existing SSB grid of a stationary cell, especially of the stationary cell 26, and starts a transmission broadcast of its own SSB. Further additionally or further alternatively, the emulator 22 can be configured to emulate the dynamic cell 23 such that the dynamic cell 23 comprises a correspondingly different tracking area identifier, especially to force a TAU.

It is noted that it might be particularly advantageous if the measurement device 24 is configured for measuring a second time period representing how long it takes until the DUT 21 detects the dynamic cell 23 after integrating the dynamic cell 23 into the neighbor cell list, especially wherein the test results comprise said second time period. For instance, the measurement device 24 may use the measurement report for measuring the second time period. Further exemplarily, the test results can comprise the second time period and/or the measurement report.

It is further noted that it might be particularly advantageous if the measurement device 24 is configured for measuring a third time period representing how long it takes until the stationary cell 26 receives the measurement report after detecting the dynamic cell 23, especially wherein the test results comprise said third time period. For instance, the measurement device 24 may use the measurement report for measuring the third time period. Further exemplarily, the test results can comprise the third time period and/or the measurement report.

Furthermore, it might be particularly advantageous if the measurement device 24 is configured for measuring a fourth time period representing how long it takes until the DUT 21 starts random access, preferably by sending a RACH preamble, after informing the DUT 21 about the existence of the dynamic cell 23, especially wherein the test results comprise said fourth time period. For instance, the measurement device 24 may use the measurement report for measuring the fourth time period. Further exemplarily, the test results can comprise the fourth time period and/or the measurement report.

Moreover, it is noted that it might be particularly advantageous if the measurement device 24 is configured for measuring a fifth time period representing how long it takes until the DUT 21 starts random access, preferably by sending a RACH preamble, after forcing the TAU, especially wherein the test results comprise said fifth time period. For instance, the measurement device 24 may use the measurement report for measuring the fifth time period. Further exemplarily, the test results can comprise the fifth time period and/or the measurement report.

It is further noted that it might be particularly advantageous if the measurement device 24 is configured for monitoring power consumption of the DUT 21, preferably during informing the DUT 21 about the existence of the dynamic cell 23 and/or measuring the first time period, especially wherein the test results comprise said power consumption. For instance, the measurement device 24 may use the measurement report for monitoring said power consumption. Further exemplarily, the test results can comprise said power consumption and/or the measurement report.

It might be particularly advantageous if the measurement device 24 is configured for testing of an uplink Doppler mismatch adjustment and/or an uplink Doppler mismatch compensation of the DUT 21, preferably based on measuring a corresponding downlink Doppler shift with respect to the DUT 21 and/or assuming an uplink Doppler shift with respect to the DUT 21, especially wherein the test results comprise a corresponding outcome of said testing of the uplink Doppler mismatch adjustment and/or of the uplink Doppler mismatch compensation of the DUT 21. For instance, the measurement device 24 may use the measurement report for testing of the uplink Doppler mismatch adjustment and/or the uplink Doppler mismatch compensation of the DUT 21. Further exemplarily, the test results can comprise said corresponding outcome and/or the measurement report.

It is noted that it might be particularly advantageous if the measurement device 24 is configured for monitoring power consumption of the DUT 21 during said uplink Doppler mismatch adjustment and/or during said uplink Doppler mismatch compensation, especially wherein the test results comprise said power consumption. For instance, the measurement device 24 may use the measurement report for monitoring said power consumption. Further exemplarily, the test results can comprise said power consumption and/or the measurement report.

With respect to the measurement report, it is noted that it might be particularly advantageous if the measurement report comprises a cell identifier and/or a power level and/or a RSRP with respect to the dynamic cell 23.

According to an exemplary use case of the system 20 of FIG. 9 or of the system 30 of FIG. 10, respectively, the emulator 22 or the system simulator, respectively, may emulate a dynamic cell with sudden birth. Said dynamic cell or the dynamic cell 23, respectively, may start transmission of SSB in context of existing cells (for instance, same band but different global synchronization channel number (GCSN) and/or physical cell identity (PCI)). Furthermore, the measurement device 24 or the measurement module, respectively, can check how long it takes until DUT or the DUT 21, respectively, reports the new cell or said dynamic cell, respectively. Said dynamic cell or the dynamic cell 23, respectively, can be on an unknown trajectory. The DUT or the DUT 21, respectively, may transmit with misaligned Doppler in uplink. The measurement device 24 or the measurement module, respectively, can verify how long it takes until the DUT or the DUT 21, respectively, has corrected the uplink Doppler, especially based on downlink Doppler.

All features described above or features shown in the figures can be combined with each other in any advantageous manner within the scope of the disclosure.

What is claimed is:

1. A method for testing a device under test, DUT, being capable of communicating with a wireless network based on cells, the method comprising the steps of:
emulating a dynamic cell,
informing the DUT about existence of said dynamic cell,
measuring a first time period representing how long it takes until the DUT detects the dynamic cell and/or initiates a connection to the dynamic cell after informing the DUT about the existence of the dynamic cell, and
outputting and/or displaying test results comprising said first time period.

2. The method according to claim 1,
wherein the step of informing the DUT about the existence of the dynamic cell comprises or is the steps of:
emulating a stationary cell with a neighbor cell list,
establishing a connection between said stationary cell and the DUT,
integrating the dynamic cell into the neighbor cell list, and
especially sending synchronization signals and/or information regarding the dynamic cell to the DUT.

3. The method according to claim 2,
wherein the step of measuring the first time period comprises or is the steps of:
detecting the dynamic cell, especially by the DUT, and
sending a measurement report regarding the dynamic cell to the stationary cell, especially by the DUT.

4. The method according to claim 2,
wherein the method further comprises the step of:
testing of a mobility procedure of the DUT by handing over from the stationary cell to the dynamic cell, especially wherein the test results comprise a corresponding outcome of said testing of the mobility procedure of the DUT.

5. The method according to claim 2,
wherein the method further comprises the step of:
testing of a reverse handover of the DUT by handing over from the dynamic cell to the stationary cell, especially wherein the test results comprise a corresponding outcome of said testing of the reverse handover of the DUT.

6. The method according to claim 1,
wherein the dynamic cell is emulated with frequency and/or Doppler shift.

7. The method according to claim 1,
wherein the dynamic cell is emulated as a low-altitude platform system, LAPS, cell and/or a high-altitude platform system, HAPS, cell.

8. The method according to claim 1,
wherein the dynamic cell is emulated as a non-terrestrial network, NTN, cell.

9. The method according to claim 1,
wherein the dynamic cell is emulated as having an unpredictable trajectory.

10. The method according to claim 2,
wherein the dynamic cell is emulated such that the dynamic cell uses a corresponding frequency of an existing stationary cell, especially of the stationary cell, to inform about the existence of the dynamic cell.

11. The method according to claim 2,
wherein the method further comprises the step of:
measuring a second time period representing how long it takes until the DUT detects the dynamic cell after integrating the dynamic cell into the neighbor cell list, especially wherein the test results comprise said second time period.

12. The method according to claim 2,
wherein the dynamic cell is emulated such that the dynamic cell uses an existing synchronization signal block, SSB, grid of a stationary cell, especially of the stationary cell, and starts a transmission broadcast of its own SSB.

13. The method according to claim 3,
wherein the measurement report comprises a cell identifier and/or a power level and/or a reference signal received power, RSRP, with respect to the dynamic cell.

14. The method according to claim to claim 3,
wherein the method further comprises the step of:
measuring a third time period representing how long it takes until the stationary cell receives the measurement report after detecting the dynamic cell, especially wherein the test results comprise said third time period.

15. The method according to claim 1,
wherein the dynamic cell is emulated such that the dynamic cell comprises a correspondingly different tracking area identifier, especially to force a tracking area update, TAU.

16. The method according to claim 1,
wherein the method further comprises the step of:
measuring a fourth time period representing how long it takes until the DUT starts random access, preferably by sending a random access channel, RACH, preamble, after informing the DUT about the existence of the dynamic cell, especially wherein the test results comprise said fourth time period.

17. The method according to claim 15,
wherein the method further comprises the step of:
measuring a fifth time period representing how long it takes until the DUT starts random access, preferably by sending a random access channel, RACH, preamble, after forcing the tracking area update, especially wherein the test results comprise said fifth time period.

18. The method according to claim 1,
wherein the method further comprises the step of:
monitoring power consumption of the DUT, preferably during informing the DUT about the existence of the dynamic cell and/or measuring the first time period, especially wherein the test results comprise said power consumption.

19. The method according to claim 1,
wherein the method further comprises the step of:
testing of an uplink Doppler mismatch adjustment and/or an uplink Doppler mismatch compensation of the DUT, preferably based on measuring a corresponding downlink Doppler shift with respect to the DUT and/or assuming an uplink Doppler shift with respect to the DUT, especially wherein the test results comprise a corresponding outcome of said testing of the uplink Doppler mismatch adjustment and/or of the uplink Doppler mismatch compensation of the DUT, and
optionally monitoring power consumption of the DUT during said uplink Doppler mismatch adjustment and/or during said uplink Doppler mismatch compensation, especially wherein the test results comprise said power consumption.

20. A system for testing a device under test, DUT, being capable of communicating with a wireless network based on cells, the system comprising:
an emulator for emulating a dynamic cell and informing the DUT about existence of said dynamic cell,
a measurement device for measuring a first time period representing how long it takes until the DUT detects the dynamic cell and/or initiates a connection to the dynamic cell after informing the DUT about the existence of the dynamic cell, and
an output and/or a display for outputting and/or displaying test results comprising said first time period.
